(19) United States
(12) Patent Application Publication
(10) Pub. No.: US 2014/0373790 A1
(43) Pub. Date: Dec. 25, 2014

(54) DISPOSABLE PET DISH AND METHOD OF ADVERTISING TO PET OWNERS

(71) Applicant: Thomas G. Asimou, Phoenix, AZ (US)

(72) Inventor: Thomas G. Asimou, Phoenix, AZ (US)

(21) Appl. No.: 14/268,995

(22) Filed: May 2, 2014

Related U.S. Application Data
(63) Continuation-in-part of application No. 12/510,193, filed on Jul. 27, 2009.

(51) Int. Cl. A01K 5/01; B65B 11/00; G09F 23/00

(52) U.S. Cl. CPC A01K 5/0121; G09F 23/00; B65B 11/00
USPC 119/61.5; 53/410

(57) ABSTRACT

A pet dish advertising apparatus has indicia operatively disposed on a dish, the dish comprising a food-safe material selected from the group consisting of polylactide, cardboard pulp, wax-coated cardboard, wax coated paper, wax-coated fabric, a translucent resinous material, a transparent resinous material, and a composite of fused fibrous and resinous materials, along with a recessed lid with a tab. Optionally a plurality of the pet dishes are contained in a tray. Also included is a method for making a pet dish with advertising. Also included are packaging configurations.

### RELATED APPLICATIONS

This application is a continuation in part application of U.S. Ser. No. 12/510,193 filed Jul. 27, 2009, which claims the benefit of U.S. Provisional Application 61/083,884 filed Jul. 25, 2008, both of which are herein incorporated by reference.

### TECHNICAL FIELD

The present invention relates to a dish and packaging for feeding a pet such as a dog or housecat and, more particularly, to a disposable pet food dish.

### BACKGROUND

Pet feeding generally occurs at least once daily. Many pet owners have reusable dishes that require cleaning after each pet feeding, or the dish imparts unpleasant odors to the owner's kitchen and/or other areas of the home. When traveling with a pet, owners dislike bringing reusable food dishes because it can be difficult to find the extra water for washing. While most pet owners appreciate the opportunity to get outdoors and walk their dogs, the unpleasant step of scrubbing and washing out the pet dish is an activity that many would prefer to avoid.

Many pet owners would prefer a fresh, quick, convenient dish to feed their pets, particularly if the cost were very desirable. An opportunity to utilize this frequent activity to communicate a commercial message to the large population of pet owners would be particularly helpful to advertisers.

### SUMMARY OF THE INVENTION

In one embodiment, there is provided a pet dish advertising apparatus. The pet dish has indicia operatively disposed on a dish. The pet dish is composed of a food-safe material selected from the group consisting of polylactide, cardboard pulp, wax-coated cardboard, wax coated paper, wax-coated fabric, a translucent resinous material, a transparent resinous material, and a composite of fused fibrous and resinous materials. Optionally the pet dish has a recessed lid with a tab. And the pet dish is packaged in a tray that has receptacles for a plurality of dishes and a handle. The receptacles can number six or twelve.

In another embodiment, there is provided a method of advertising to pet owners. This method has the steps of: providing a disposable pet feeding dish, wherein the disposable dish comprises a food-safe material selected from the group consisting of polylactide, cardboard pulp, wax-coated cardboard, wax-coated paper, wax-coated fabric, a translucent resinous material, a transparent resinous material, and a composite of fused fibrous and resinous materials and a tabbed and recessed lid; operatively disposing indicia on said dish; and distributing said dish to consumers. Optionally, the method has an additional step of enclosing a plurality of the pet dishes in packaging with an optional handle. Optionally the number of dishes enclosed in the packaging is six or twelve.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIG. 1 is a perspective view of an exemplary embodiment of a pet dish advertising apparatus in accordance with the present invention;

FIG. 2 is a side elevational view thereof;

FIG. 3 is a perspective view of another exemplary embodiment;

FIG. 4 is a side sectional view of the embodiment of FIG. 3;

FIG. 5 is a side sectional view of another exemplary embodiment;

FIG. 6 is a top plan view of another exemplary embodiment;

FIG. 7 is a top plan view of another exemplary embodiment;

FIG. 8 is a side sectional view of the embodiment of FIG. 7;

FIG. 9 is a side sectional view of another exemplary embodiment;

FIG. 10 is a top plan view of the embodiment of FIG. 9;

FIG. 11 is a side sectional view of another exemplary embodiment;

FIG. 12 is a side sectional view of another exemplary embodiment;

FIG. 13 is a bottom perspective view of another exemplary embodiment;

FIG. 14 is a top plan view of another exemplary embodiment;

FIG. 15 is a side sectional view of another exemplary embodiment;

FIG. 16 is a side sectional view of another exemplary embodiment;

FIG. 17 is a bottom plan view of the embodiment of FIG. 16;

FIG. 18 is a side elevational view of another exemplary embodiment;

FIG. 19 is a bottom plan view of another exemplary embodiment;

FIG. 20 is a top plan view of another exemplary embodiment wherein a first dish is stacked atop a second dish;

FIG. 21 is a front elevational view of the dish of the embodiment of FIG. 20 showing a first dish stacked atop a second dish and configured for use;

FIG. 22 is a side elevational view of the embodiment of FIG. 20 showing a first dish stacked atop a second dish in a superimposed configuration for storage and shipment;

FIG. 23 is a side elevational view of another exemplary embodiment of a generally triangular dish in accordance with the present invention with other such dishes stacked atop it in a superimposed configuration for storage and shipment;

FIG. 24 is a top plan view of the dish of the embodiment of FIG. 23 stacked atop another such dish, configured for use;

FIG. 25 is a side elevational view of the embodiment and configuration shown in FIG. 24;

FIG. 26 is a side sectional view of a portion of a bottom of the embodiment of FIG. 23 forming a groove in accordance with the present invention;

FIG. 27 is a see-through view of packaging for the stacked inventive pet dishes. This container has a top cut out for hanging on a store display rack;

FIG. 28 is a see-through view of different packaging for the stacked inventive pet dishes. This compact packaging can be provided in a store bin;

FIG. 29 is a see-through view of the compact packaging for the stacked inventive pet dishes. This configuration has a cut-out for hanging the package on a store display rack;

FIGS. 30a and 30b show a preferred design of the inventive pet dish. FIG. 30a is a cross-sectional view, and FIG. 30b is a side elevational view of the inventive pet dishes;

FIG. 31 shows a carrying tray for a half dozen inventive pet dishes;

FIGS. 32a and 32b show another form of packaging for the inventive pet dishes. FIG. 32a is an end view showing the packaging in profile. FIG. 32b shows a side elevational view of the new packaging configuration;

FIGS. 33a, 33b, 33c and 33d show another embodiment of the packaging. FIG. 33a is a side three-quarter view showing see-through packaging and the bottom of the bowls. FIG. 33b shows the opposite end of packaging 33a; here the top of the bowl is visible and the tabbed lid can be seen. FIG. 33c is an end view of the packaging and bowls; the tabbed bowl is visible. FIG. 33d is a side cutaway view of the packaging and inventive pet dishes; and

FIG. 34 is a side elevational view of a preferred embodiment of the pet bowl with a tabbed, recessed lid. The tabbed lid is easily removed to reveal dog food.

### DETAILED DESCRIPTION

The inventor has dogs with whom he has travelled. He has experienced first hand the frustration of feeding his pet in a parking lot and in a hotel room, neither of which are convenient for using reusable pet dishes or cleaning up the dishes. He determined to come up with a useful, inexpensive alternative. In working on his invention, the inventor also opined that major companies, such as hotel chains, would want to distribute the disposable pet food bowls, but also to advertise and remind the pet owner that they were providing the convenient pet dish either gratis or at great savings. Advertising linked to loving experiences (like feeding “man's best friend”) can create very powerful, positive relationships with brands, even incentivize pet owners to use the advertised brand. In addition, major purveyors of pet products can put advertise on the bowls, too. Most other advertiser surfaces in the environment are already taken and are becoming more expensive. Advertising on the pet food bowls would provide a new opportunity for advertisers to get close to pet owners. For even greater convenience, the inventive food bowls are filled with food or water.

The invention will now be described.

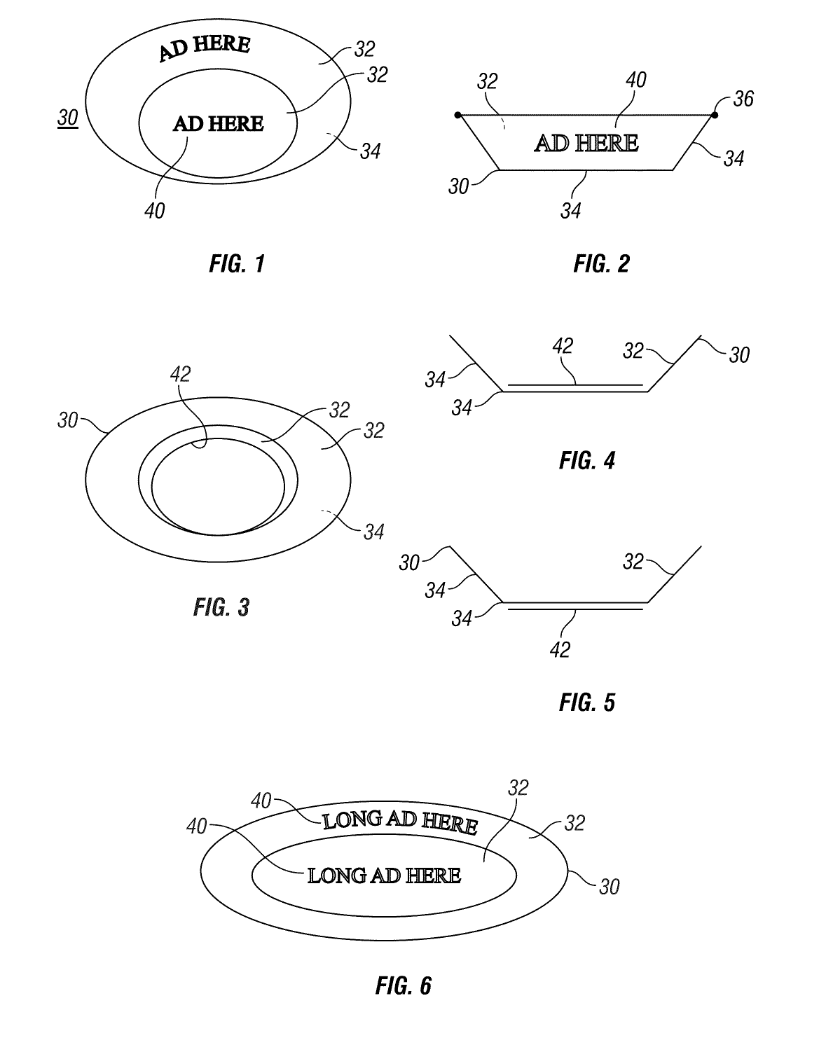

In FIG. 1 (perspective view) and FIG. 2 (side elevational view), an exemplary embodiment of disposable pet dish advertising apparatus in accordance with the present invention (hereinafter, the shorter construction, “exemplary embodiment,” will be used) is shown generally at 30 and includes a dish and indicia 40 operatively disposed on the dish. The dish has a generally upward-facing inner surface 32, parts of which may be horizontally oriented and parts of which may be inclined, and a generally downward-facing outer surface 34, parts of which may be horizontally oriented and parts of which may be inclined. The dish 30 may be generally round as viewed from above. The dish 30 is formed of cardboard pulp resembling that of a paper egg carton. A dish 30 so formed may be wax coated. Alternatively, the dish 30 is formed of paper or fabric and coated with wax. Alternatively, the dish 30 is formed of a translucent or transparent resinous material such as polyethylene or other polymer, or a composite of fibrous and resinous materials fused by adhesion, melting, curing, drying or the like. The dish 30 may have a turned rim 38 for stiffness or for easy manipulation, as shown in FIG. 2.

A popular material for disposable food containers is PLA, or polylactide, also called poly(lactic acid), a polymer made from corn starch (US), tapioca parts (Asia), or sugarcane (most of the world). PLA has a relatively low use temperature, which is acceptable with water and dog food. PLA is so safe it is even used in resorbable implants for human use. In addition, it is fully recyclable.

The indicia 40 may comprise graphics and text and are disposed on a surface of the dish 30. Preferably, the indicia 40 are disposed to be perceived by a person viewing the inner surface 32 of the dish 30. FIG. 1, a perspective view, shows indicia 40 disposed directly on the inner surface 32 at two locations. FIG. 2, a side view, shows indicia 40 disposed directly on the outer surface 34.

FIG. 3 (perspective view) and FIG. 4 (side sectional view) show another exemplary embodiment in which the dish 30 has an inner surface 32 on which is disposed an indicia-bearing label 42. The label 42 is of paper, plastic film or the like. The label 42 is placed loose in the dish 30, where a consumer will be likely to notice it, pick it up, and read it. Alternatively, the label 42 is glued or fused to the inner surface 32. Both of these embodiments are preferably made entirely of natural, food-grade materials that would not cause injury or distress if ingested by a pet or by a child.

FIG. 5 shows a side sectional view of an alternative embodiment, made like the embodiment of FIG. 4, but in which the dish 30 has an outer surface 34 on which is disposed an indicia-bearing label 42. In this embodiment, preferably, the dish 30 is transparent or translucent and a consumer is able to perceive the indicia 40 of the label 42 through the dish 30 when viewing the inner surface 32 of the dish 30. Text, if included, should be reversed (virtual image) on the label 42 and should be visible from the sticky side of the label 42 before the label 42 is applied.

FIG. 6 shows a top view of another exemplary embodiment in which the dish 30 has an exaggerated oval shape and the indicia 40 are oriented lengthwise relative to that shape, providing a convenient vehicle for text in banner format.

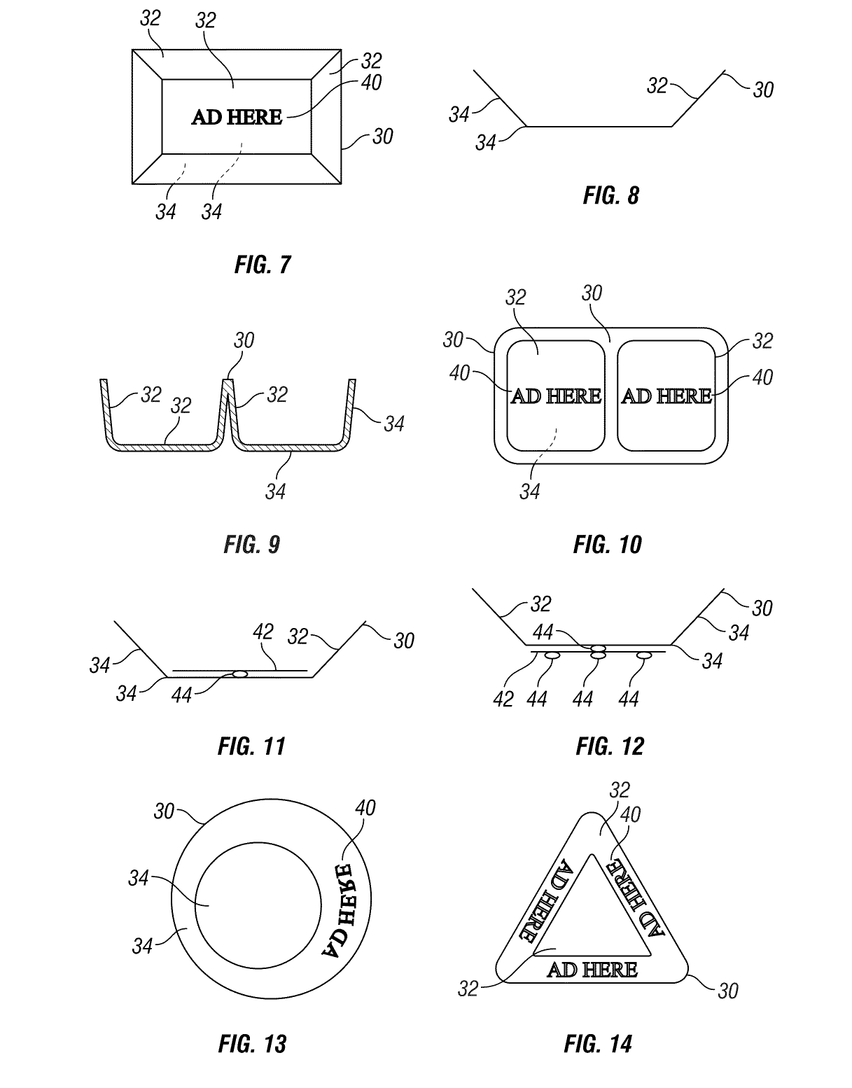

FIG. 7 (top view) and FIG. 8 (side sectional view) show another exemplary embodiment in which the dish 30 has a rectangular shape as viewed from above. Indicia 40 are shown disposed on the inner surface 32.

FIG. 9 (side sectional view) and FIG. 10 (top view) show another exemplary embodiment in which the inner surface 32 is divided to provide convenient side-by-side presentation of food for two small pets or of food and water (in which case wax or resinous components are preferred to retard saturation of the dish 30 material). Indicia 40 are shown disposed at two locations on the divided inner surface 32.

FIG. 11 shows a side sectional view of another exemplary embodiment in which a wad of adhesive 44 detachably adheres an indicia-bearing label 42 to the inner surface 32. A consumer is likely to notice the label 42 and detach it from the inner surface 32 before feeding a pet. This involves the consumer with the label 42 and increases the likelihood that the consumer will read it, thereby furthering the goal of conveying a commercial message.

FIG. 12 shows a side sectional view of another exemplary embodiment in which a wad of adhesive 44 detachably adheres an indicia-bearing label 42 to the outer surface 34. A consumer is likely to notice the label 42 and detach it before feeding a pet. This involves the consumer with the label 42 and increases the likelihood that the consumer will read it, thereby furthering the goal of conveying a commercial message. The adhesive 44 is of the type commonly used to attach a protective film to a new consumer product, and may, alternatively, take the form of an electrostatic treatment or film rather than a wad of gummy or gelatinous material.

As is further illustrated by FIG. 12, the label 42 is double-sidedly adhesive, providing a means to conveniently and temporarily anchor the dish 30 to a floor surface. The behaviors of setting the dish 30 down on the floor and picking it up (this latter step entails detaching the dish 30 from the label 42, the label 42 from the floor, or both) involves the consumer with the label 42, increasing the likelihood that the advertising message is printed on the label 42 will be perceived. Indeed, when two or three wads of adhesive 44 anchor the label 42 to the floor, while only one wad anchors the dish 30 to the label 42, it is likely that the consumer will first see the label 42 through the transparent dish 30, then lift the dish 30 and see the label 42 anchored to the floor, and finally detach the label 42 from the floor, further involving the consumer and providing added opportunities for the consumer to perceive the advertising message.

FIG. 13 shows a bottom perspective view of an alternative embodiment in which text is reverse (virtual image) disposed on the outer surface 34 of a transparent or translucent dish 30. The indicia 40 are perceptible and the text readable through the dish 30 as viewed through the inner surface 32.

FIG. 14 shows a top view of an alternative embodiment in which the dish 30 has a triangular shape. A triangle has a greater circumference per area than a circle or square. Consequently, this embodiment provides ample placement for text in banner format on an inclined portion of the inner surface 32 or outer surface 34.

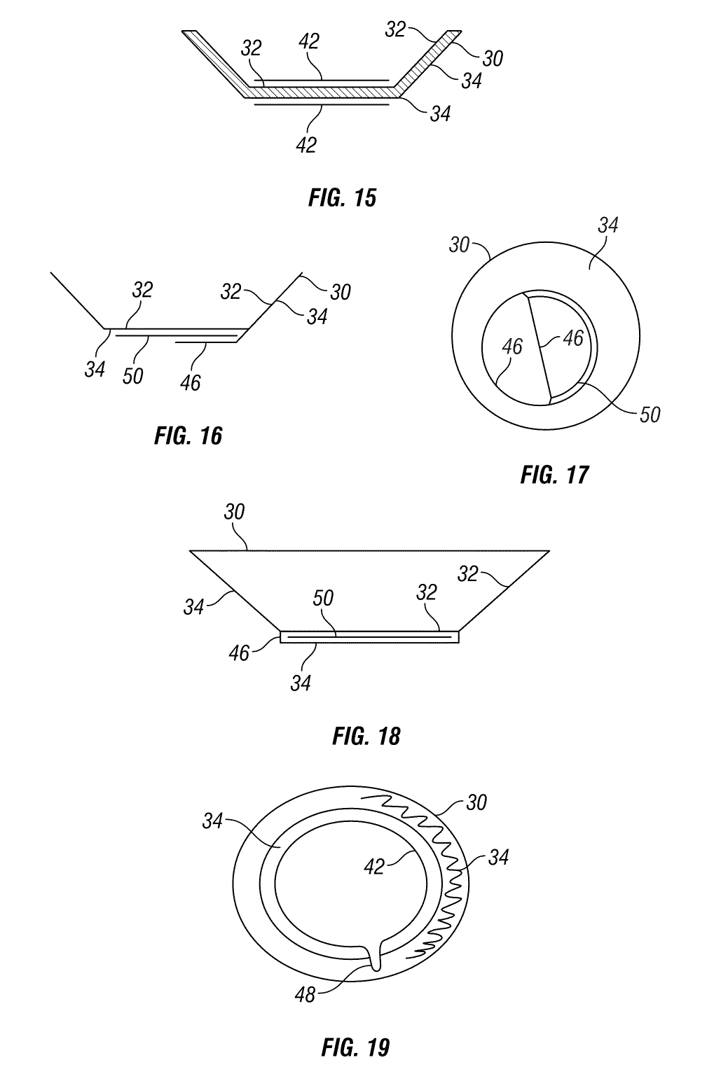

FIG. 15 shows a side sectional view of another exemplary embodiment in which the dish 30 is formed of a transparent material and indicia 40 are cooperatively disposed on the inner surface 32 and outer surface 34 and perceptible together in a view of the inner surface 32. Superimposed indicia 40 provide an opportunity to generate a moire pattern which, with its shimmering effect, is useful in attracting a consumer's attention to any text or graphic message that is included in the indicia 40.

FIG. 16 (side sectional view) and FIG. 17 (bottom view) show another exemplary embodiment wherein the dish 30 comprises an undercut false bottom 46 in which indicia-bearing media 50 are removably disposed. Exemplary media 50 include cards and leaflets. Media 50 so disposed in a false bottom 46 are likely to drop from the dish 30 as the dish 30 is being transferred from a carton or package to a place where a pet is to be fed. A consumer is likely to become involved with the media 50 and, in the process, likely to perceive the advertising message contained in the indicia 40. Preferably, the dish 30 is transparent, providing another opportunity for the consumer to notice the media 50 by viewing it through the dish 30.

FIG. 18 is a side view of another exemplary embodiment wherein the false bottom 46 defines a plurality of openings. Media 50, either on a continuous strip or on discrete cards, may be fed into the false bottom 46 or withdrawn therefrom via these openings.

FIG. 19 is a bottom view of another exemplary embodiment wherein an indicia-bearing label 42 is detachably coupled to the dish 30 and the label 42 comprises a tab 48 facilitating detachment of the lid or label 42 from the outer surface 34.

Also in accordance with the present invention is an exemplary method of advertising to pet owners, comprising the steps of providing a disposable pet feeding dish 30; operatively disposing indicia 40 on the dish 30; and distributing the dish 30 to consumers who will perceive the indicia 40 when feeding their pets.

In another exemplary method, the dish 30 is at least partly transparent and has an inner surface 32 and an outer surface 34, the indicia 40 being disposed on the outer surface 34 and being readable as viewed through the inner surface 32. The method further comprises a step of shipping the dish 30 to a distributor before the indicia 40 are printed on or attached to the dish 30. This method allows the advertising method to be selected and associated with the dish 30 after the demographic characteristics of the intended consumer are determined

In another exemplary method, the indicia 40 are contained on media 50 and the media 50 are separably coupled to the dish 30. This exemplary method further comprises a step of dispensing the media 50 from the dish 30 when the dish 30 is manipulated by a consumer. As a practical matter, media 50 inserted in a false bottom 46 of the dish 30 or dropped into the dish 30 will attract the consumer's attention, either because the consumer will wish to remove them before adding food or because the media 50 drop from the dish 30 and flutter to the floor.

In another exemplary method, the indicia 40 are contained on media 50, the media 50 are detachably adhered to the dish 30, and the method further comprises a step of displaying the indicia 40 when the media 50 are detached from the dish 30. A consumer will, for example, pull a label 42 or other media 50 from the inner surface 32 of the dish 30, optionally with the aid of a tab 48, before feeding the pet.

In another exemplary method, where indicia 40-bearing media 50 are detachably adhered to an outer surface 34—especially a downward-facing surface—of the dish 30, further steps of detachably adhering the media 50 to an environmental surface—usually the floor—when the dish 30 is placed for feeding, detaching the media 50 from the dish 30 when retrieving the dish 30 after feeding, and thereafter displaying the indicia 40 while the media 50 adhere to the environmental surface provide multiple opportunities to direct the consumer's attention to the advertising message contained in the indicia 40.

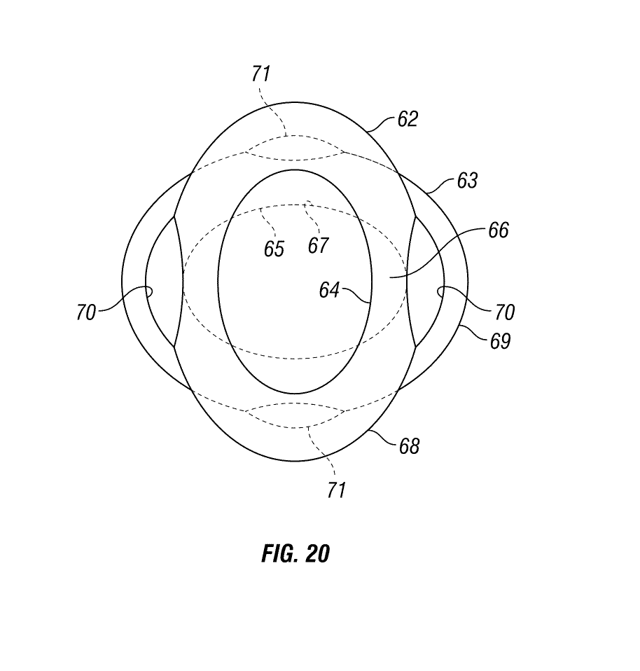

FIG. 20 is a top plan view of another exemplary embodiment wherein a first, shallow, generally elliptical dish 62 has a bottom 64, a sidewall 66, and a rim 68. The sidewall 66 and the rim 68 form opposite, laterally projecting leaves 70. The first dish 62 is shown stacked upon a second such dish 63, which has its own bottom 65, sidewall 67, and rim 69, the sidewall 67 and rim 69 forming opposite, laterally projecting leaves 71. The first dish 62 is positioned at a right angle to the second dish 63. Thus positioned and oriented, the first dish 62 rests upon the second dish 63 and, in particular, the major axis portions of the sidewalls 66 of the first dish 62 are stably cradled in the leaves 71 of the second dish 63 (dotted lines represent features of the second dish 63 obscured from direct view by the first dish 62). Consequently, the bottom 64 of the first dish 62 is spaced apart from the bottom 65 of the second dish 63 and the second dish 63 has capacity for holding water, which may be poured into the second dish 63 and which is accessible to a pet which may drink or lap the water, inserting its snout or tongue beneath the leaves 70 of the first dish 62 and above the rim 69 of the second dish 63. Meanwhile, the first dish 62 has capacity to hold food.

It will be appreciated that the first dish 62 and the second dish 63 are generally the same shape and are provided in a size appropriate for the pet that is to be fed. Although the leaves 70 of the first dish 62 and the rim 69 of the second dish 63 appear not to be spaced far apart, even a short-faced animal, such as a Pug, a Boston Terrier, or a Bulldog, may drink by inserting its tongue between them and lapping the water. Optionally, the first dish 62 and second dish 63 may be made more eccentric (greater ratio of major axis to minor axis of the ellipses described), with the result that the leaves 70 will be spaced farther from the rims 69, making it easier for the animal to drink. Optionally, the first dish 62 and second dish 63 are boat-shaped or rectangular instead of elliptical.

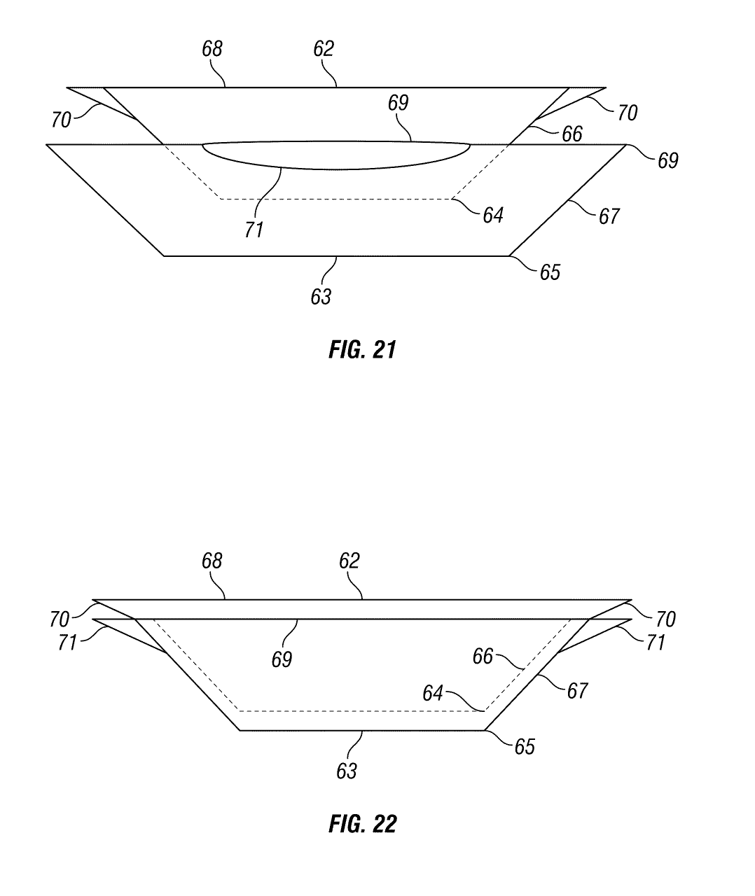

FIG. 21 is a front elevational view of the embodiment of FIG. 20. A first dish 62 has a bottom 64, a sidewall 66, a rim 68, and leaves 70. A second dish 63 has a bottom 65, a sidewall 66, a rim 69, and leaves 71. The first dish 62 rests in the second dish 63 as described with reference to FIG. 20. In this figure, the first dish 62 is viewed from an end and the second dish 63 is viewed from a side. The dotted lines represent portions of the first dish 62 obscured from this view by the second dish 63. The bottom 64 and sidewalls 66 of the first dish 62 are spaced apart from the bottom 65 and sidewalls 67 of the second dish 63, allowing the second dish 63 to have capacity for water and permitting the animal to lap the water.

FIG. 22 is a side elevational view of the embodiment of FIG. 20 and FIG. 21 shown configured for storage or shipment. A first dish 62 is shown compactly nested in a second dish 63, mutually superimposed rather than rotated at a right angle. For clarity of illustration, a token separation in shown between the first dish 62 and the second dish 63; however, it will be appreciated that the dishes will settle compactly in this configuration.

With reference to FIG. 20, FIG. 21 and FIG. 22, the user unpacks two dishes (which may be supplied stacked compactly, all in the same orientation), places water in one and food in the other, and stacks the food dish atop the water dish, oriented at right angles thereto. The resulting stable configuration of the two dishes saves space. Advertising indicia (not shown in these figures) are applicable to the bottoms and inside and outside the sidewalls.

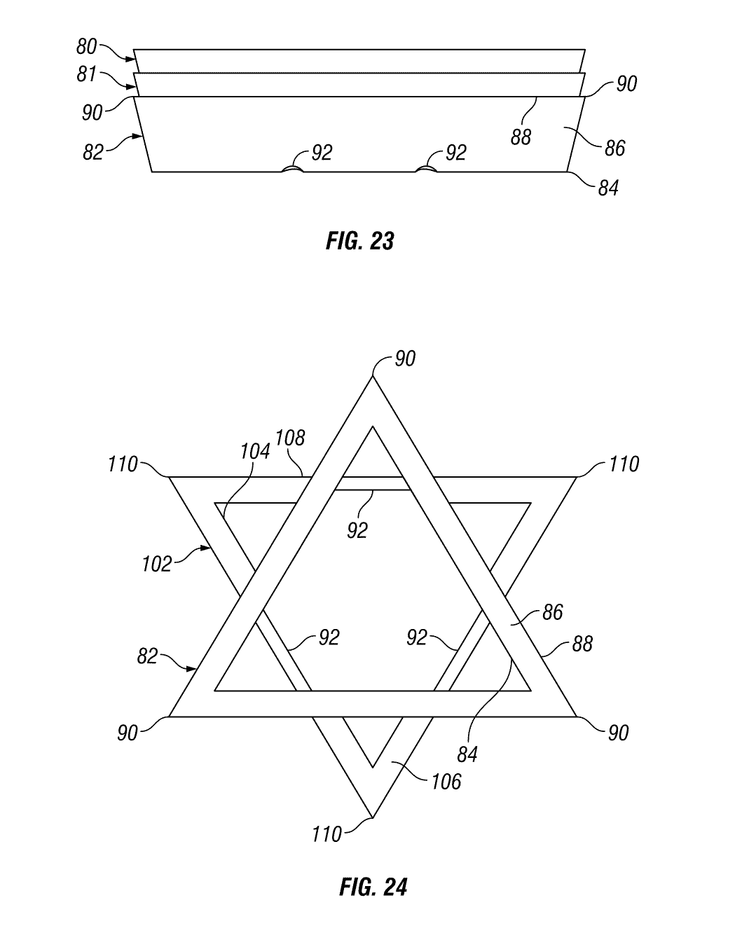

FIG. 23 is a side elevational view of another exemplary embodiment of a dish 82 in accordance with the present invention having a bottom 84, a sidewall 86, a rim 88, corners 90, and grooves 92 formed in the bottom 84 intermediate the corners 90. Also shown are additional dishes 81 and 82 of the same design stacked compactly in a mutually superimposed configuration atop the described dish 82 for storage and shipping

FIG. 24 is a top plan view of a first dish 82 of the embodiment of FIG. 23 stacked atop a second such dish 102. First dish 82 has a rim 88, sidewalls 86, corners 90, bottom 84, and grooves 92 formed in the bottom 84 and traversing the bottom 84 and extending to adjacent sidewalls 86 intermediate the corners 90. Second dish 102 has a rim 108, sidewalls 106, a bottom 104, corners 110, and grooves (not shown because obscured) formed in the bottom intermediate the corners 110 in the same manner as the grooves 92 of the first dish 82. The grooves 92 of the first dish 82 rest on the rim 108 of the second dish 102, stabilizing the first dish 82 atop the second dish 102 and spaced apart therefrom, so that the second dish 102 has capacity to hold water. The first dish 82 is rotated sixty degrees relative to the second dish 102, exposing the second dish 102 proximate the corners 110 thereof so that a pet may drink from the second dish 102.

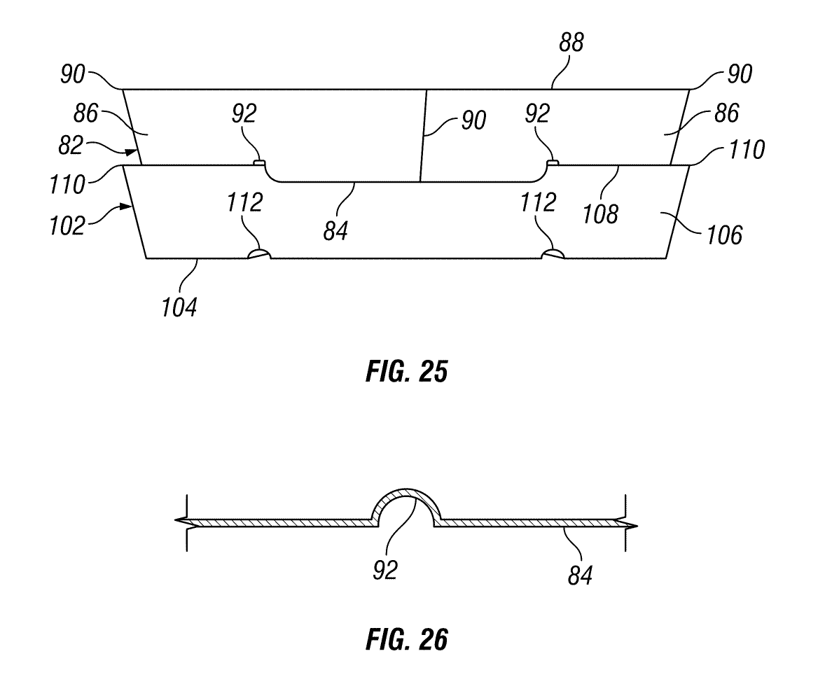

FIG. 25, a side elevational view of the embodiment and configuration shown in FIG. 24, shows the first dish 82 having rim 88, sidewalls 86, bottom 84, comers 90 and grooves 92. The first dish 82 is placed atop the second dish 102, which has a rim 108, sidewalls 106, bottom 104, comers 110, and grooves 112. The view is shadowed to indicate that the middle of the three comers 90 is projecting toward the viewer, overhanging a sidewall 106 of the second dish 102 with the grooves 92 stabilized atop the rim 108.

FIG. 26 shows a sectional view of a bottom 84 forming a groove 92.

With reference to FIGS. 23, 24, 25, and 26, the user procures two dishes 82 and 102 (which may be supplied stacked compactly, all in the same orientation), adds water to one and food to the other, and stacks the food dish atop the water dish, forming a stable, accessible, space-saving dish combination for feeding and watering a pet. Advertising indicia (not shown in these figures) are applicable to the bottoms and inside and outside the sidewalls.

Also with reference to the embodiment of FIGS. 23, 24, 25, and 26, optionally, the first dish 82 and second dish 102 are boat-shaped or rectangular, or even elliptical as in the embodiment shown in FIGS. 20-22, instead of triangular, with the rims 88 and 108 and the grooves 92 and 112 shaped, located and oriented transversely in the bottoms 84 and 104 so that the same compactly stacked storage and shipping configuration and vertically spaced-apart feeding configuration are provided for—i.e., the dishes nest compactly when exactly superimposed, and the grooves of an upper dish rest stably on the rim of a lower dish when the dishes are rotated a given angle (for boat and rectangle, as with the elliptical, by 90 degrees) one relative to another. In other words, the groove feature detailed with reference to this triangular embodiment is applicable to other shapes including the elliptical, in which case the leaves 70 and 71 shown in FIGS. 20-22 can be eliminated. In a rectangular dish, the grooves are spaced and oriented to conform to the portions of the rims that they will rest on top of In an elliptical dish, the grooves are spaced, oriented and curved to conform to the portions of the rims that they will rest on top of.

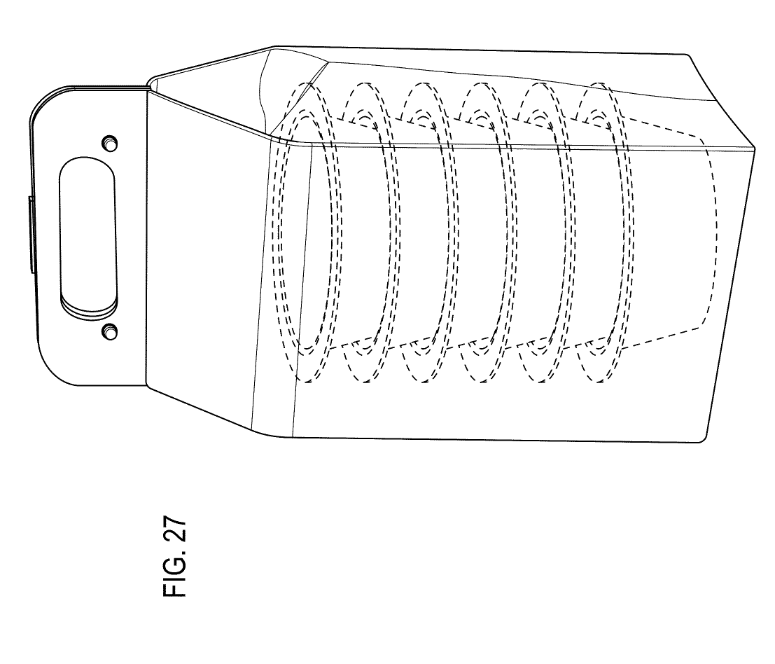

FIG. 27 is a see-through view of packaging for the stacked inventive pet dishes. This container has a top cut out for hanging on a store display rack.

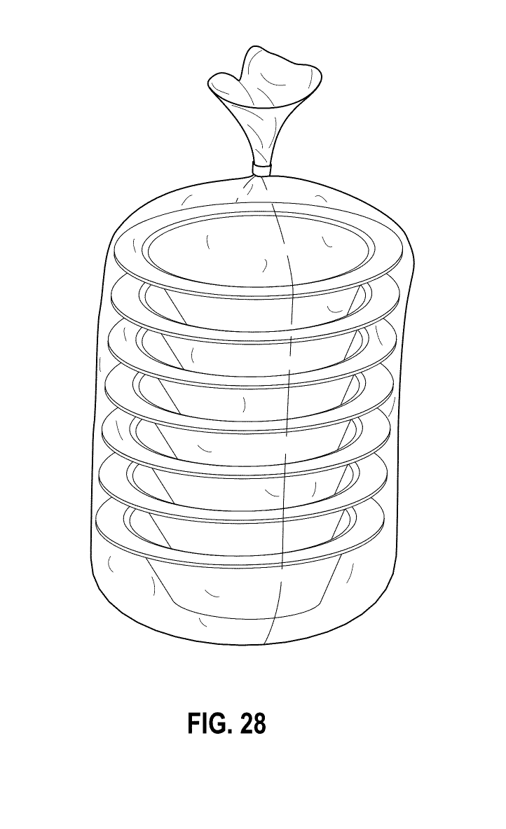

FIG. 28 is a see-through view of different packaging for the stacked inventive pet dishes. This compact packaging can be provided in a store bin.

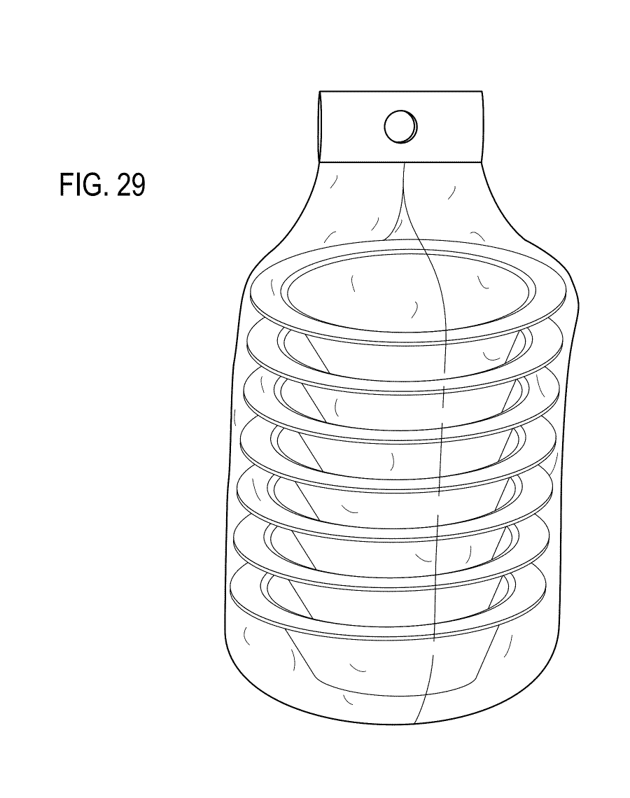

FIG. 29 is a see-through view of the compact packaging for the stacked inventive pet dishes. This configuration has a cut-out for hanging the package on a store display rack.

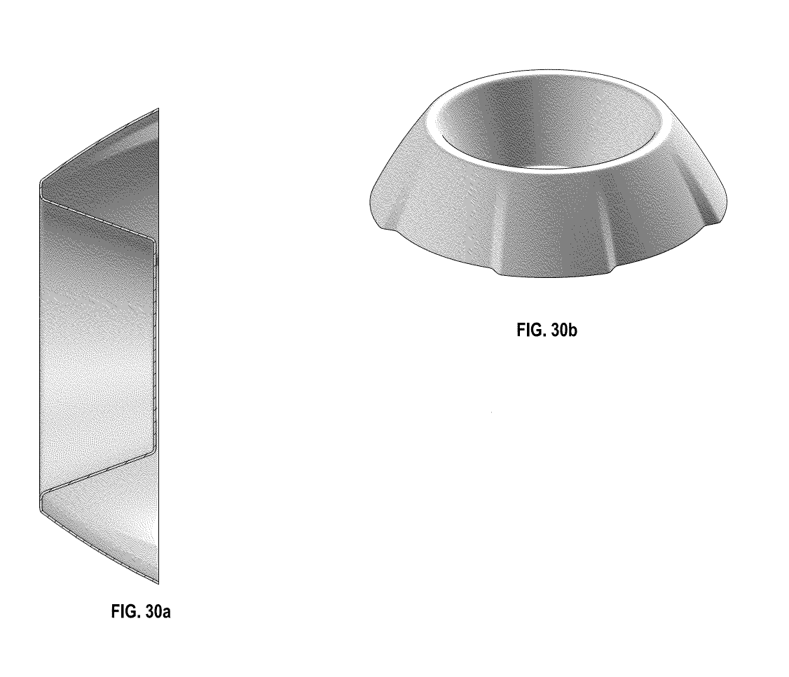

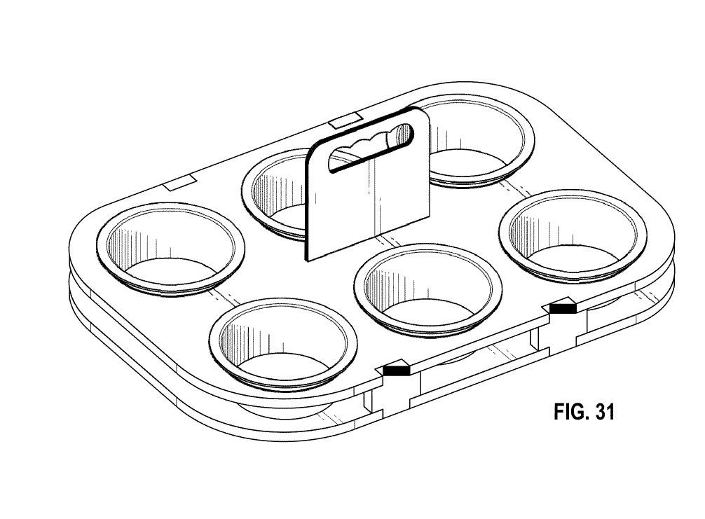

FIGS. 30a and 30b show a preferred design of the inventive pet dish. FIG. 30a is a cross-sectional view, and FIG. 30b is a side elevational view of the inventive pet dishes.

FIG. 31 shows a carrying tray for a half dozen inventive pet dishes.

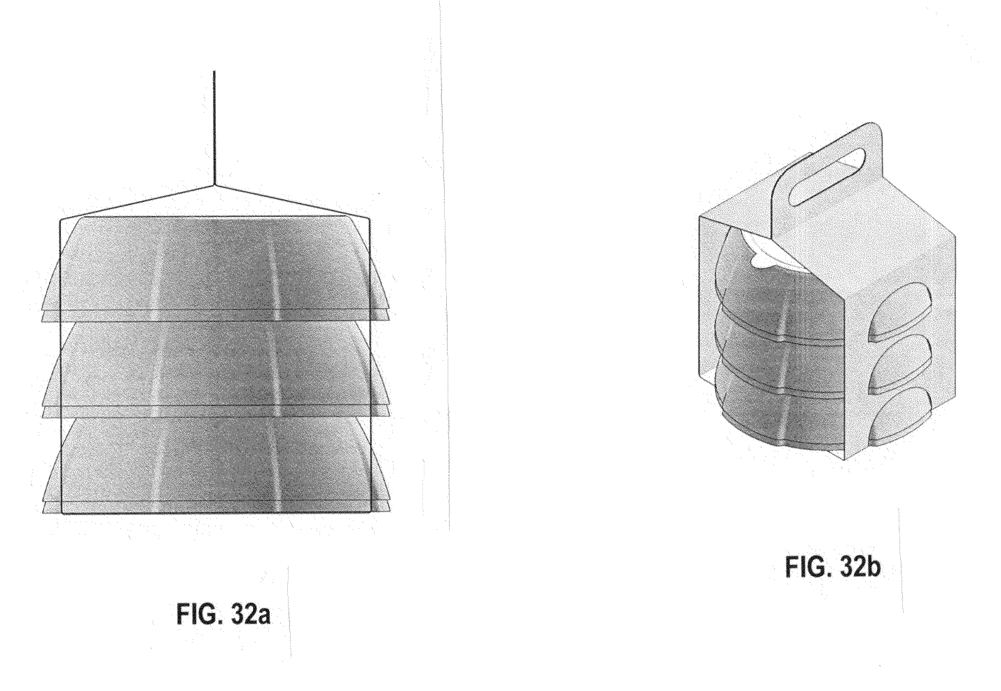

FIGS. 32a and 32b show another form of packaging for the inventive pet dishes. FIG. 32a is an end view showing the packaging in profile. FIG. 32b shows a side elevational view of the new packaging configuration.

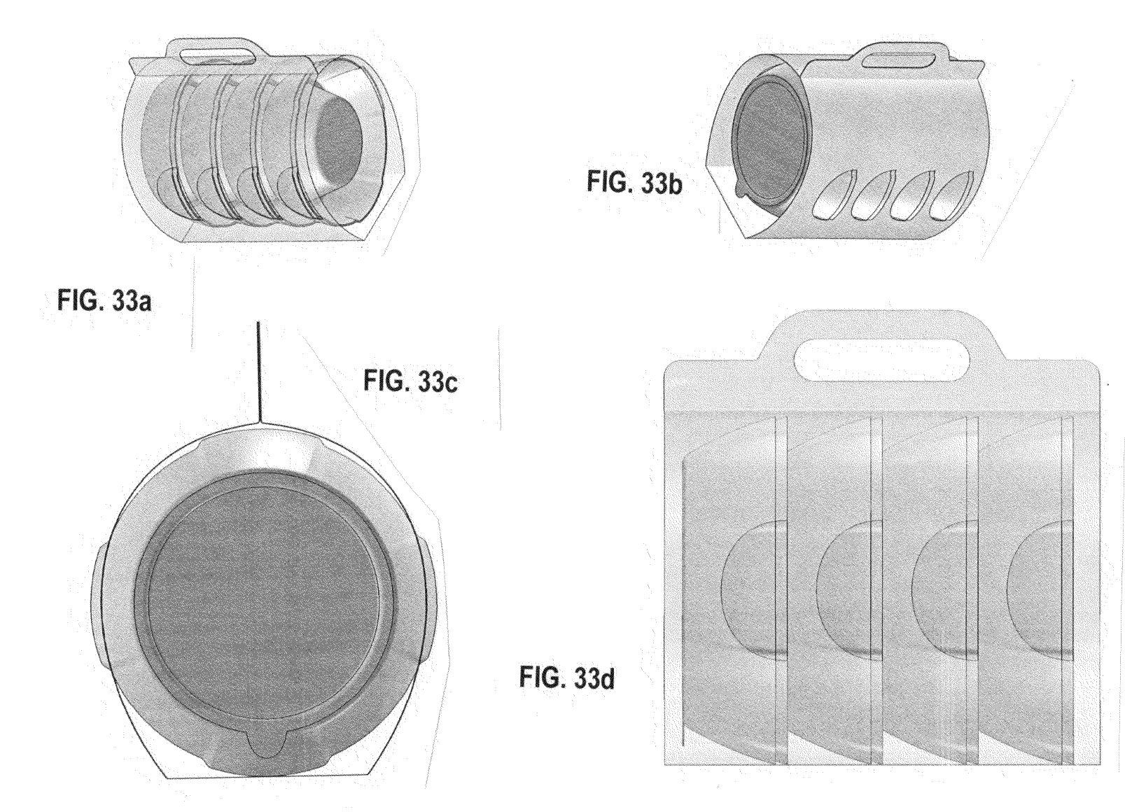

FIGS. 33a, 33b, 33c and 33d show another embodiment of the packaging. FIG. 33a is a side three-quarter view showing see-through packaging and the bottom of the bowls. FIG. 33b shows the opposite end of packaging of FIG. 33a; here the top of the bowl is visible and the tabbed lid can be seen. FIG. 33c is an end view of the packaging and bowls; the tabbed bowl is visible. FIG. 33d is a side cutaway view of the packaging and inventive pet dishes.

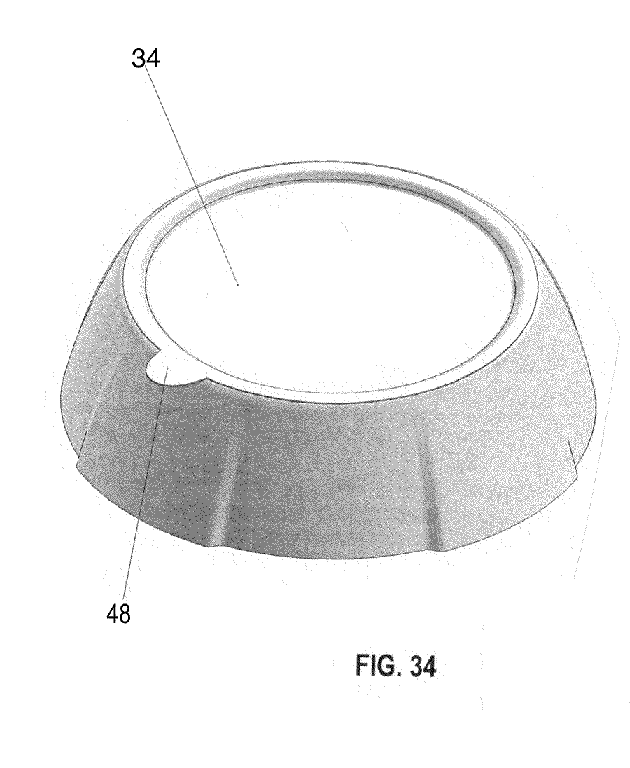

FIG. 34 is a side elevational view of a preferred embodiment of the pet bowl with a tab 48 on a recessed lid 34. The tabbed lid is easily removed to reveal dog food or an empty dish to be filled with water or food.

With reference to the various embodiments described in accordance with the present invention, the dish comprises cardboard pulp resembling that of a paper egg carton; alternatively, wax-coated cardboard, paper product or fabric; alternatively, a translucent or transparent resinous material such as polyethylene or other polymer, or a composite of fibrous and resinous materials fused by adhesion, melting, curing, drying or the like. The dish may have a turned rim for stiffness or for easy manipulation.

As can be seen from the drawing figures and from the description, each embodiment of the disposable pet dish advertising apparatus and advertising method in accordance with the present invention solves a problem by addressing an advertiser's need to direct a consumer's attention to an advertising message contained in indicia operatively associated with the pet dish.

Although specific embodiments have been illustrated and described herein, those of ordinary skill in the art will appreciate that any arrangement calculated to achieve same purposes can be substituted for the specific embodiments shown. This disclosure is intended to cover any and all adaptations or variations of various embodiments of the invention. It is to be understood that the above description has been made in an illustrative fashion, and not a restrictive one.

Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

In the foregoing description, if various features are grouped together in a single embodiment for the purpose of streamlining the disclosure, this method of disclosure is not to be interpreted as reflecting an intention that the claimed embodiments of the invention require more: features than are expressly recited in each claim. Rather, as the following claims reflect, inventive subject matter lies in less than all features of a single disclosed embodiment. Thus the following claims, and such other claims as may later be added, are hereby incorporated into the description of the embodiments of the invention, with each claim standing on its own as a separate preferred embodiment.

1. A pet dish advertising apparatus, comprising indicia operatively disposed on a dish, the dish comprising
a. a food-safe material selected from the group consisting of polylactide, cardboard pulp, wax-coated cardboard, wax coated paper, wax-coated fabric, a translucent resinous material, a transparent resinous material, and a composite of fused fibrous and resinous materials; and
b. a recessed lid with a tab.

2. The pet dish of claim 1 wherein the pet dish is contained inside a container comprising a tray with receptacles for a plurality of dishes and a handle.

3. The pet dish of claim 2 wherein the receptacles number six.

4. The pet dish of claim 2 wherein the receptacles number twelve.

5. The pet dish of claim 1 wherein the dish contains pet food.

6. A method of advertising to pet owners, comprising the steps of:
a) providing a disposable pet feeding dish, wherein the disposable dish comprises
i) a food-safe material selected from the group consisting of polylactide, cardboard pulp, wax-coated cardboard, wax-coated paper, wax-coated fabric, a translucent resinous material, a transparent resinous material, and a composite of fused fibrous and resinous materials; and
ii) a recessed lid with a tab;
b) operatively disposing indicia on said dish; and
c) distributing said dish to consumers.

7. The method of claim 6 wherein after step b, there is an additional step of enclosing a plurality of the pet dishes in packaging that also has optionally has a handle.

8. The method of claim 6 wherein the packaging encloses six dishes.

9. The method of claim 6 wherein the packaging encloses twelve dishes.
